(19) United States
(12) Patent Application Publication
(10) Pub. No.: US 2026/0228270 A1
(43) Pub. Date: Aug. 6, 2026

(54) USING LARGE LANGUAGE MODELS BASED ON DIFFERENT SEARCHES

(71) Applicant: Honeywell International Inc., Charlotte, NC (US)

(72) Inventors: Nagarjuna Reddy Chevuru, Bangalore (IN); Mamata Vishvanath Lohar, Pune (IN); Manish Manohar Karlekar, Bangalore (IN)

(21) Appl. No.: 19/046,526

(22) Filed: Feb. 6, 2025

(51) Int. Cl. G06F 16/383; G06F 40/284; G06F 40/289

(52) U.S. Cl. CPC G06F 16/383; G06F 40/284; G06F 40/289

(57) ABSTRACT

Approaches for generating a response for a user based on different searches on a set of ranked documents by using a large-language model. In an example, a query received from a user is processed to generate a query embedding, a term-based query, and a semantic query. Once generated, each of the query embedding, the term-based query and the semantic query may be executed on to determine a first set, a second set and a third set of documents from a document collection. The documents thus obtained are scored to identify set of ranked documents. Thereafter, the ranked documents may be used by a large-language model to generate a response for the user based on the set of ranked documents.

### BACKGROUND

Large Language Models (LLMs) are advanced machine-learning based systems trained on extensive datasets to process and generate human-like text. Such responses may be provided in response to prompts or questions that may be provided in the form of text-based inputs aligned with human language. LLMs have been observed to be functionally capable and efficient in performing a wide range of operations, which include, but are not limited to, natural language processing tasks, including text generation, translation, summarization, question answering, and information retrieval. LLMs have proven particularly useful in automating knowledge-intensive tasks, offering solutions in fields such as legal research, medical diagnostics, and customer support by extracting, synthesizing, and presenting information with enhanced linguistic fluency.

### BRIEF DESCRIPTION OF DRAWINGS

Systems and/or methods, in accordance with examples of the present subject matter are now described and with reference to the accompanying figures, in which:

FIG. 1 illustrates a system for generating a response for a user based on different searches on a set of ranked documents by using a large-language model, in accordance with an example of the present subject matter;

FIG. 2 illustrates an environment comprising a system for generating a response for a user based on different searches on a set of ranked documents by using a large-language model, in accordance with another example of the present subject matter;

FIG. 3 illustrates a query processing system for generating a response for a user based on different searches on a set of ranked documents by using a large-language model, in accordance with an example implementation of the present subject matter;

FIG. 4 illustrates an environment comprising a query processing system for generating a response for a user based on different searches on a set of ranked documents by using a large-language model, in accordance with an example implementation of the present subject matter;

FIG. 5 illustrates a method for generating a response for a user based on different searches on a set of ranked documents by using a large-language model, in accordance with yet another example implementation of the present subject matter;

FIG. 6 illustrates another method for generating a response for a user based on different searches on a set of ranked documents by using a large-language model, in accordance with another example implementation of the present subject matter;

FIG. 7 illustrates a method for preparing an embedding repository, an inverted index, and a knowledge graph, which when implemented in an environment are for generating a response for a user based on different searches on a set of ranked documents by using a large-language model, in accordance with yet another example implementation of the present subject matter; and

FIG. 8 illustrates a non-transitory computer-readable medium for generating a response for a user based on different searches on a set of ranked documents by using a large-language model, in accordance with an example implementation of the present subject matter.

### DETAILED DESCRIPTION

As described previously, Large Language Models (LLMs) are machine learning systems trained on extensive datasets to process and generate text that closely resembles human-like responses. These models are designed to respond to prompts or questions presented in natural language, producing coherent and contextually appropriate outputs. LLMs are functionally capable of performing a wide range of natural language processing tasks, including, but not limited to, text generation, translation, summarization, question answering, and information retrieval. They have demonstrated significant utility in automating knowledge-intensive processes, offering solutions across domains such as legal research, medical diagnostics, and customer support by efficiently extracting, synthesizing, and presenting information with remarkable linguistic precision.

Despite the advancements in machine-learning based system, particularly in the deployment of large language models (LLMs), several technical challenges persist that hinder their efficient application as well as implementation. Such challenges are evident, especially in domain-specific scenarios such as legal, technical, or medical fields which utilizes highly contextual information. As has been observed, LLMs primarily operate based on statistical correlations derived from training data, and in many instances fail to comprehend the context pertaining to the content within a document, nor they may possess true semantic or contextual understanding of the queries that may be posed. Such limitations often results in outputs that may appear coherent but lack nuanced comprehension of the contextual or domain-specific intent behind user queries. In certain instances, the responses may end up even being incomplete, or even worse, incorrect. Consequently, users are compelled to repeatedly refine their queries to achieve acceptable results, leading to inefficiencies and frustration in information retrieval.

To a large extent, some challenges may be addressed by use of ontologies or knowledge graphs. As may be understood, an ontology is a structured framework or formal representation that defines the concepts, entities, and their relationships within a specific domain of knowledge. It may also implement a shared vocabulary and a set of rules for organizing, categorizing, and linking information (thereby establishing relationships), enabling machines to interpret and reason about data in a meaningful and context-aware manner. Using ontologies for LLM-based systems provide a number of technical advantages. For example, the structural representation of information may overcome misinterpretation or omission of relevant contextual information, thereby increasing the accuracy of responses and the efficiency of data retrieval in both structured and unstructured contexts. The generated responses are more relevant, accurate, and context-aware, particularly in domains requiring a high degree of semantic precision, such as legal, medical, or technical fields, or fields (or related applications) which may otherwise be dependent on large volumes of document pertaining to such fields. Ontology-driven frameworks have exhibited data coherence and enhanced the overall usability and reliability of information processed by LLMs, while handling massive volumes of information.

Although ontologies provide numerous technical advantages, conventional information retrieval systems integrated with LLMs may frequently provide inadequate prioritization while presenting information in response to user queries. Such issues may arise due to improper ranking and filtering of vast document datasets effectively. As a result, retrieved outputs often include irrelevant or extraneous content, diminishing their practical utility and accuracy for end users.

Approaches for generating a response for a user based on different searches on a set of ranked documents by using a large-language model, are described. The approaches as described herein enable finding data with the correct context using LLMs by integrating results obtained from ontologies (or knowledge graphs) with results obtained from a semantic search and a search performed on inverted indices. In an example, a user query may be received. The user query once received may be processed. The processing of the query is to generate a query embedding, a term-based query, and a semantic query. To this end, the query may be parsed to determine one or more key terms. Based on the key terms, the query embedding may be prepared. The query embedding may be understood as a numerical representation which captures the semantic meaning of the query that has been received from the user.

The term-based query may also be generated based on one or more key terms that may be present in the user query, which may correspond to full-text query. Examples of such searches include queries for parts with specific component name or number, or any other specific text based search. Based on such key terms, the term-based query may be generated. Similar to the query embedding and the term-based query, the semantic query may also be generated based on the user query. In an example, the key terms from the user query may be processed to identify terms of interest, concepts, and relationships between various terms of interest. Once identified, the same may be used for generating a query knowledge graph which corresponds to context and the meaning of the query. Once the query knowledge graph is available, the same may be used for obtaining the semantic query.

Once obtained, the query embedding, the term-based query, and the semantic query may be executed on an embedding repository, an inverted index, and a knowledge graph, respectively. In the instance of the query embedding being executed on the embedding repository, the embedding repository comprises one or more embeddings depicting semantic context and relationships between terms present in a collection of documents. The collection of documents comprises documents that may be pertinent to a knowledge domain. Knowledge domain may be understood as a specific area of expertise or subject matter that the machine-learning based system may be implemented with or configured/trained on. Example of knowledge domain may include, information having degree of generality or specificity, pertaining to specific fields such legal, technical, or medical fields. In another example, the knowledge domain may pertain to various functional, operational or any other type of information pertaining to organizational resources, such as industrial facilities, or such. It may be noted that such examples of knowledge domains are only indicative. The present approaches are applicable for other fields without deviating from the scope of the present subject matter.

The embedding repository may be populated based on embeddings that are prepared from the documents comprising the collection of documents. To this end, each of the documents (e.g., a document in PDF format) within the collection of documents may be processed to obtain one or more segmented document portions (e.g., single page of PDF). The segmented document portions thereafter may be parsed to obtain text-based content or keywords. The keywords in turn are processed to form chunks, with the chunks being used to prepare embeddings. The embedding may be stored in the embedding repository. In a similar manner, the chunks may be used for building an inverted index and a knowledge graph. As may be understood, the embedding repository, the inverted index and the knowledge graph, are based on the collection of documents.

Returning to the present example, the results of execution of the query embedding, term-based query, and the semantic query, are collected and compiled as the first set, second set, and a third set. It may be noted that each of the first set, second set, or the third set, may include common documents. Once these respective sets are obtained, the documents in each of the first set, second set, and third set, may be scored. Based on the scoring, a final rank for each of the documents may be determined. In an example, the final rank is determined based on a weight factor attributed to the score of each of the documents in the first set, the second set, and the third set. The weight factor attributed to the score is determined based on type of the query received from the user. For example, in instances where the user query which otherwise would be requiring semantic alignment may require higher value for weights which are associated with results or documents that were present in the first set. In a similar manner, queries which would require finding documents based on specific keywords would entail higher value of weights which are associated with results that are present in the second set. In such a manner, different weights may be used depending on the nature of the query provided by the user.

The final rank, as determined above, may be associated with each documents within the collection of documents. Documents having a final rank greater than a predefined threshold may then be provided to a large-large language model, based on which the large-language model may provide a response to the query initially provided by the user. The above approaches provide an output which is based on combining ontology, semantic search, and inverted indexes, thereby optimizing retrieval efficiency and as well as furthering contextual accuracy. In addition, the present approaches rely on ontological relationships which are present in knowledge graphs to accordingly adapt the outcome depending on the different contexts and user intents, and also based on the query received from the user, thereby overcoming technical challenges posed by existing systems in handling complex queries and large datasets.

The above approaches have been described in the context of retrieving one or more documents from a documents collection which may be utilized and implemented for in a variety of applications and for various industry vertical. For example, the present approaches may be adopted in the legal domain where legal queries may be posed. In a different example, the present approaches may be implemented in medical institutions or other industrial organizations, wherein which one or more users may pose queries and would be able to receive contextually relevant and accurate information to various operation or functional aspects of such an organizations. As will be explained further in greater detail, the present approaches improve the performance of systems which use large-language model (LLM) for document retrieval and for responding to queries received from one or more users. As expressed previously, said examples are applicable across such fields, with such applications being only further examples of the claimed subject matter.

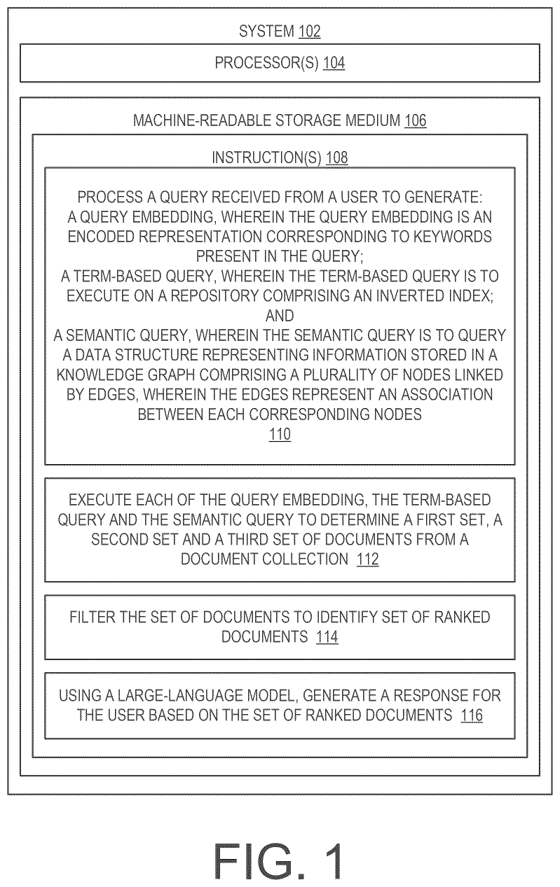

FIG. 1 illustrates a query processing system 102, also referred to as system 102, which by using large-language model (LLM) is capable of furthering performance of document retrieval and for enhancing the relevance of replies in response to a user query, as per one example. The system 102, as will be explained further, may be implemented for responding to multiple queries that may be received from a plurality of users. Such users may be operating within different knowledge domains and/or industry verticals. Examples of different knowledge domains include, but is not limited to, legal, technical, or medical fields. The present approaches are relevant to applications which require processing large volumes of information and provide accurate and contextually relevant information in response to queries that may be posed by users. It may be noted that although specific examples of knowledge domain and/or applications are highlighted, the present approaches are relevant to any domain, without deviating from the scope of the present subject matter.

Returning to the present example, the system 102 includes a processor 104 and a machine-readable storage medium 106 which is coupled to, and accessible by, the processor 104. The system 102 may be implemented in any computing system, such as a storage array, server, desktop or a laptop computing device, a distributed computing system, or the like. Although not depicted, the system 102 may include other components, such as interfaces to communicate over the network or with external storage or computing devices, display, input/output interfaces, operating systems, applications, data, and other software or hardware components (all of which have not been depicted).

The processor 104 may be implemented as a dedicated processor, a shared processor, or a plurality of individual processors, some of which may be shared. The machine-readable storage medium 106 may be communicatively coupled to the processor 104. Among other capabilities, the processor 104 may fetch and execute computer-readable instructions, including instructions 108, stored in the machine-readable storage medium 106. The machine-readable storage medium 106 may include non-transitory computer-readable medium including, for example, volatile memory such as RAM (Random Access Memory), or non-volatile memory such as EPROM (Erasable Programmable Read Only Memory), flash memory, and the like. The instructions 108 may be executed to classify the hardware components of the computing device.

In an example, the processor 104 may fetch and execute instructions 108. In one example, as a result of the execution of the instructions 110, the system 102 may process a query received from a user. The query may be processed to generate a query embedding, a term-based query, and a semantic query. In one example the query embedding is an encoded representation corresponding to keywords which may be present in the query. To this end, the query may be parsed to identify one or more keywords that may be pertinent to an underlying context with which the query may correspond with.

The term-based query is also generated based on the query received from the user. The term based query thus obtained may then be executed on a repository comprising an inverted index. The semantic query, in a similar manner, is to query a data structure representing information which is stored in a knowledge graph. As may be understood, knowledge graph may be considered as a data model describing a knowledge domain typically within an organization, or a particular subject area. The knowledge graph, amongst other things, may provide context for how such different entities are related. The nodes of the knowledge graph may correspond to specific values of different objects representing such different entities. Each of the nodes of the knowledge graph may be interconnected by edges which represent relation between the different objects. As may be understood, nodes connected by edges may be contextually interrelated.

Thereafter, the instructions 112 may be executed to further cause the execution of the query embedding, term-based query and the semantic query. In an example, the query embedding is executed on an embedding repository. The term-based query and the semantic query, on the other hand, are executed on an inverted index and a knowledge graph. In an example, the embeddings within the embedding repository, The document collection may be considered as any repository comprising large volumes of documents or information records. Such documents or information records may pertain to a specific knowledge domain or an industry vertical.

The execution of the query embedding, the term-based query, and the semantic query may yield a first set of documents, a second set of documents, and a third set of documents. Each of the first set, second set, or the third set, may be retrieved from a document collection. It may be noted that the different sets of documents as exemplified may not include unique documents-different (or all sets, as the case may be) may include the same document.

The instructions 114 may be executed to score the set of documents to identify one or more ranked documents. In an example, the documents within the first set, the second set, and the third set, may be common or may be uniquely present in any one of these sets. In an example, to identify the ranked documents, the instructions 114 may score each document in the first set, the second set, and the third set. Based on the score of the documents in the first set, the second set, and the third set, and a weight factor, a final rank may be determined. Based on a predefined condition and the final rank determined for each document, the set of ranked documents may be identified.

Once the set of ranked documents have been identified, the instructions 116 may be executed to generate a response to the query received from the user. In an example, the response to the query may be generated using a large-language model.

The above functionalities performed as a result of the execution of the instructions 108, may be performed by different programmable entities within a computing environment. Such programmable entities may be implemented through any computing systems, which may be implemented either on a single computing device, or multiple computing devices. As will be explained, various examples of the present subject matter are described in the context of a system which may be used for using large-language model (LLM) for document retrieval in response to a user query. These and other examples are further described with respect to the remaining figures.

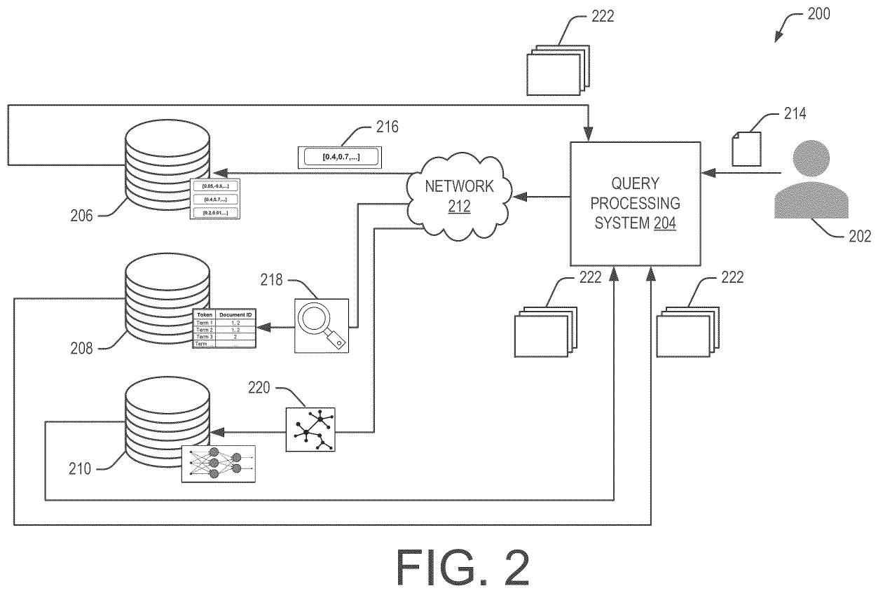

FIG. 2 illustrates an environment 200 comprising a user 202 and query processing system 204. The query processing system 204 is similar to the system 102. The query processing system 204 (hereinafter referred to as the system 204) may be implemented within different set-ups. For example, the environment 200 may correspond to an organization in which the system 204 may be implemented. The system 204 may be used, amongst other things, to provide information in response to the queries received from the user 202. The environment 200 may also be any environment in which the system 204 is implemented and designed to interact with users (such as user 202) through natural language processing. In such instances, the user 202 may pose one or more questions or queries to the system 204 in a spoken language based-prompts. In response to the question posed by the user 202, the system 204 may provide a response as a conversational reply to the query from the user 202.

The system 204, to be able to respond to the query received from the user 202, may implement a large-language model, which would be trained to understand the query from the user 202 and generate a response in a human-like text. The responses may be provided in real-time, and may possess context-aware dialogue capabilities to respond to diverse user inputs/additional queries. The system 204 may be trained to respond to queries on a broad range of topics, or may be trained to respond to queries pertaining to specific domains like law, healthcare, customer support, or other fields with specialized information. For example, legal domain uses specific terminology, phrases (e.g., maxims in Latin) or concepts that may be relevant for specific legislations. Similarly, information in healthcare domain also may be specific to various physiological conditions that may be relevant to different parts, organs, diseases, and such. Such fields or domains, which may also be referred to as knowledge domains, generally may be associated with information or knowledge in specific areas, expertise or field of study that encompasses the concepts, terminology, or methodologies, that may be specific to that subject. The information which may be relevant to the respective fields would influence the type and context of the responses that may be provided in response to any query. Therefore, factoring in such information would ensure a more accurate and contextually relevant response.

As discussed previously, by using ontologies and/or knowledge graphs machine learning systems using large-language models are capable of responding to contextually varying queries with relevant responses. The present approaches, as briefly discussed above, not only account for responses that are obtained based on knowledge graphs, but also consider responses that may be obtained by executing the user query on an inverted index and an embedding repository. The system 204 is capable of ranking the results obtained from the embedding repository, inverted index, and the knowledge graph, and providing to a large-language model for generating a response to the query received from the user 202. To this end, the system 204 may be in communication with various repositories, namely an embedding repository 206, an inverted index 208, and a knowledge graph 210. It may be noted that a reference to either the embedding, inverted index or a knowledge graph would also include a reference to a repository or any persistent storage for retaining embeddings, an inverted index, or the knowledge graph.

The system 204 is communicatively coupled to the embedding repository 206, the inverted index 208, and the knowledge graph 210 via a network 212. In an example, the network 212 may be a wireless network or a combination of a wired and wireless network. The network 212 can also include a collection of individual networks, interconnected with each other and functioning as a single large network, such as the Internet. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), Long Term Evolution (LTE), and Integrated Services Digital Network (ISDN). Depending on the terminology, the communication network includes various network entities, such as gateways and routers; however, such details have been omitted to maintain the brevity of the description.

In operation, the system 204 may receive a query 214 from the user 202. The query 214 received from the user 202 may be presented in natural language (i.e., without adhering to any querying specific syntax). The manner in which the query 214 may be posed may vary without limiting the scope of the present subject matter. For example, the query 214 (although in a natural language) may be provided to the system 204 in the form of a text-based input. In another example, the query 214 may be provided in the form of an audio input provided by the user 202. In such a case, the system 204 may convert the audio-based input to a text-based input which may then be processed as the query 214. It may be noted that the manner in which the query 214 is provided to the system 204 may be implemented using a variety of different techniques. Such other techniques would be different examples covered by the scope of the accompanying claims.

The query 214 once received is processed by the system 204, to generate a query embedding 216, a term-based query 218, and a semantic query 220. The query embedding 216, the term-based query 218, and the semantic query 220 may then be executed on the embedding repository 206, the inverted index 208, and the knowledge graph 210 to provide different sets of documents, such as the document(s) 222. The different sets of document(s) 222 are retrieved consequent to the execution of the query embedding 216, the term-based query 218, and the semantic query 220. For the purposes of the present description, these document(s) 222 are collected and compiled as the first set, the second set, and the third set.

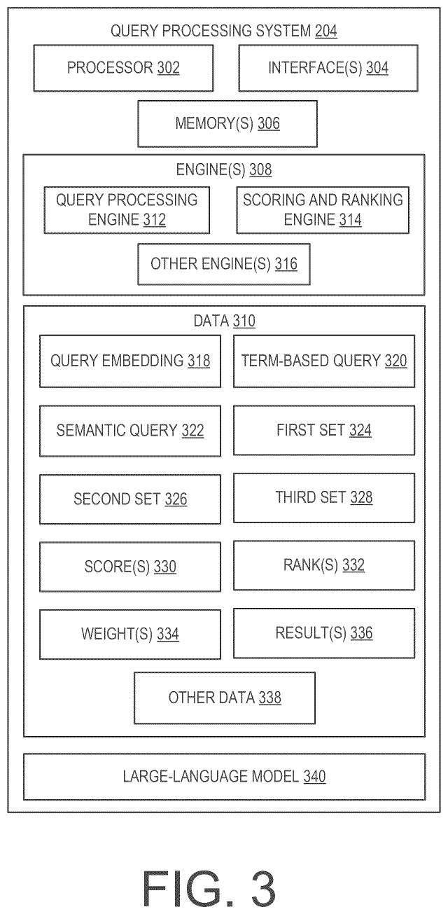

As mentioned above, the first set, the second set, and the third set are obtained as a result of the execution of the query embedding 216, the term-based query 218, and the semantic query 220. It may be noted that the documents present in either of the first set, the second set, and the third set, need not be unique but may be common. For example, it is possible that a given document, say document D1, may be present in the first set and the second set, if it conforms to the parameters in the query embedding 216 as well as the parameters that may be specified in the term-based query 218. Although explained in relation with a single document, i.e., document D1, it is possible that other documents may be commonly present across the first set, the second set, and the third set. In some instances, the documents indicated in the first set, the second set, and the third set may be unique, without deviating from the scope of the present subject matter. The first set, the second set, and the third set may, instead of including copies of the documents that may have been obtained from a document collection, may include references of such documents in the first set, the second set, and the third set. For the purposes of the present description, referring to ‘documents’ present in any one or more of the first set, the second set, and the third set, would not be restricted to any one such implementation. As will be further explained in conjunction with FIG. 3, the results of the execution of the query embedding 216, the term-based query 218, and the semantic query 220, may be further processed to obtain ranked documents, which may then be used by a large-language model for providing a response to the query 214 provided by the user 202.

FIG. 3 illustrates one or more logical blocks of the system 204, as per an example. Although not depicted in FIG. 3, the system 204 is communicatively coupled to the embedding repository 206, the inverted index 208, and the knowledge graph 210. The system 204 includes a processor 302, interface(s) 304, and memory(s) 306. The processor 302 may be implemented as microprocessors, microcomputers, microcontrollers, digital signal processors, central processing units, state machines, logic circuitries, and/or other devices that manipulate signals based on operational instructions. The interface(s) 304 may allow the connection or coupling of the system 204 with one or more other devices, through a wired (e.g., Local Area Network, i.e., LAN) connection or through a wireless connection (e.g., Bluetooth®, Wi-Fi). The interface(s) 304 may also enable intercommunication between different logical as well as hardware components of the system 204. The interface(s) 304 may also enable the system 204 to communicate with other entities, such as the repository 210, or other devices or systems (not shown in the figures) which may be present within the facilities 202.

The memory(s) 306 may be a computer-readable medium, examples of which include volatile memory (e.g., RAM), and/or non-volatile memory (e.g., Erasable Programmable read-only memory, i.e., EPROM, flash memory, etc.). The memory(s) 306 may be an external memory, or internal memory, such as a flash drive, a compact disk drive, an external hard disk drive, or the like. The memory(s) 306 may further include data which either may be utilized or generated during the operation of the system 204.

The system 204 may further include engine(s) 308 and data 310. The engine(s) 308 may be implemented as a combination of hardware and programming, for example, programmable instructions to implement a variety of functionalities of the engine(s) 308. In examples described herein, such combinations of hardware and programming may be implemented in several different ways. For example, the programming for the engine(s) 308 may be executable instructions. Such instructions may be stored on a non-transitory machine-readable storage medium which may be coupled either directly with the system 204 or indirectly (for example, through networked means). In an example, the engine(s) 308 may include a processing resource, for example, either a single processor or a combination of multiple processors, to execute such instructions. In the present examples, the non-transitory machine-readable storage medium may store instructions that, when executed by the processing resource, implement engine(s) 308. In other examples, the engine(s) 308 may be implemented as electronic circuitry. In one example, the engine(s) 308 may be implemented through a machine-learning model that implements machine-learning techniques, statistical techniques, or probabilistic techniques. Examples of such techniques may include expert systems, support vector machines (SVM), neural networks, or the like.

The engine(s) 308 includes a query processing engine 312, and other engine(s) 316. The other engine(s) 316 may further implement functionalities that supplement functions performed by the system 204 or any of the engine(s) 308. The data 310, on the other hand, includes data that is either stored or generated as a result of functions implemented by any of the engine(s) 308 or the system 204. It may be further noted that information stored and available in data 310 may be utilized by the engine(s) 308 for performing various functions to be implemented by the system 204. In an example, data 310 may include query embedding 318, the term-based query 320, and semantic query 322. The query embedding 318, the term-based query 320 and the semantic query 322 are similar to the query embedding 216, the term-based query 218, and the semantic query 220 (as discussed above). Proceeding further, the data 310 may include the first set 324, the second set 326, the third set 328, score(s) 330, rank(s) 332, weight(s) 334, result(s) 336 and other data 338. In an example, the memory(s) 306 may further include a large-language model 340.

In operation, the query 214 provided by the user 202 may be received by the system 204. Once received, the query processing engine 312 may process the query 214 to generate the query embedding 216, the term-based query 218, and the semantic query 220, which in turn are stored as query embedding 318, term-based query 320, and semantic query 322 within data 310. Different approaches may be followed for generating the query embedding 318, term-based query 320, and semantic query 322. Such approaches are all different examples and still would fall within the scope of the claimed subject matter.

In an example, for generating the query embedding 318, the query processing engine 312 may segment the input text forming part of the query 214 into one or more discrete units, or words. The segmented units may be collated into a logical sequence or set, the elements of which include each of the words that may be appearing in the query 214. For example, the query processing engine 312 may segment an example text string “What are the environmental laws in Country A?” may be transformed into the sequence [“What”, “are”, “the”, “environmental”, “laws”, “in”, “Country A”, “?”]. In an example, the terms thus obtained may be stored as other data 338.

The query processing engine 312 may further process the terms thus gathered to remove formatting or punctuation, or any other elements which do not lend to a context to the question posed. For example, the query processing engine 312 may convert the case of the words into lower case, may drop punctuation marks or may drop certain words altogether (e.g., dropping conjunctions, prepositions, characters, punctuation marks, or such).

Once the terms have been processed, the query processing engine 312 may generate one or more embeddings. Embeddings may be considered as an encoded representation of the semantic meaning of the words into an array or vector of numbers. As may be understood, in such a representation words with similar meanings are represented by similar vectors in a high-dimensional vector space. To this end, the query processing engine 312 may subject the text-based terms to a transformer model, into a series of numbers which may be arranged in an array. As may be understood, a transformer model is a type of deep learning architectural model that is used for natural language processing (NLP) and other areas of machine learning. Such types of models have been found to be useful due to their efficiency, scalability, and performance.

Returning to the present example, the query processing engine 312 may process the initial set of terms to [“environment law Country C”], which then may be processed to generate an array of numbers, such as [0.21, −0.34, 0.67, . . . , −0.12]. It may be noted that the example array depicting the ‘embedding’ is only a representative example. The values of the different numbers present in the array may differ based on the transformer model, or any other neural network model, used. Once the array (which may be referred to as a vector, if represented in a higher-dimensional vector space) may be stored as the query embedding 318. The query embedding 318 thus saved in the system 204, is a vector which may then be used for searching and identifying documents based on the comparison between the vector/embedding corresponding to the query 214 and the vector/embedding corresponding to one or more documents. A match or a similarity between these vectors would indicate that the concept of the one or more document thus determined, is contextually similar to the concept that may be the subject of the query 214. In an example, example, the similarity between such vectors may be determined using cosine similarity approaches. Other approaches for determining the similarity may also be adopted without deviating from the present subject matter.

The query processing engine 312 may also process the query 214 to generate the term-based query 320 and the semantic query 322. For generating the term-based query 320, the query processing engine 312 may process the query 214 to obtain segmented keywords, as explained in relation to the generation of the query embedding 318. Once the keywords are obtained, a query may be structured based on one or more of the keywords as the parameter. In an example, the query thus generated may be stored as term-based query 320.

For generating the semantic query 322, the query processing engine 312 may parse the query 214 received from the user 202 to determine one or more named entities. In an example, a named entity may be considered as representative of any real-world object or entity instances. For example, New York may be considered to be a named entity for a ‘city’. As may be understood, determination of such named entities is termed as named entity recognition and involves identifying such named entities, in text which may otherwise be unstructured. In an example, such named entity may be stored in other data 338. Proceeding further, the query processing engine 312, based on the named entities may generate semantic query 322. The semantic query 322 may be in the form of a graph query language. Examples of such a structured query language includes, but is not limited to, SPARQL or Cypher. Other forms of query language may also be used without deviating from the scope of the present subject matter.

As explained above, the query embedding 318, the term-based query 320, and the semantic query 322 are generated by the query processing engine 312. The above are only examples, and the above-mentioned queries may be generated through other mechanisms without impacting the scope of the claimed subject matter. It may also be noted that the query embedding 318, the term-based query 320, and the semantic query 322 may be generated in any order, or may be generated simultaneously, without limiting the scope of the subject matter in any manner.

Once the query embedding 318, the term-based query 320, and the semantic query 322 (collectively referred to as queries 318, 320, 322), are generated, the query processing engine 312 may cause the execution of said the queries 318, 320, 322 on the embedding repository 206, the inverted index 208 and the knowledge graph 210, respectively. Based on the parameters that are specified in the respective queries 318, 320, 322, the documents from a document collection may be identified. The document collection may correspond to the domain knowledge of one or more specific fields. In an example, the documents that may be retrieved based on the execution of the queries 318, 320, 322, may be collected, compiled and stored within the system 204 as first set 324, second set 326, and third set 328. For example, the execution of the query embedding 216 on the embedding repository 206 yields documents which are stored as the first set 324. In a similar manner, documents retrieved as a result of the execution of the term-based query 218 and the semantic query 220 may be stored as the second set 326 and the third set 328, respectively.

The identification of the documents in the document collection, which conform with the parameters specified in the respective queries 318, 320, 322 may differ depending on the type of query. For example, in case of the query embedding 216, the query processing engine 312 may determine the similarities (e.g., cosine similarity) between the vector/embedding corresponding to the query 214 and the vector/embedding corresponding to the documents within the document collection. For the term-based query 218, the keyword or terms provided as parameters specified in the term-based query 218 are used as the basis for identifying and searching for documents in the document collection. For the semantic query 220, the names entities in the semantic query 220 is used as the basis for searching the documents in the document collection.

The documents within the first set 324, second set 326, and the third set 328 may be further processed to identify one or more ranked documents, which are then provided to trained large-language model for generating a response to the query 214. To this end, the documents within the first set 324, the second set 326, and the third set 328 may be initially scored. For example, with respect to the first set 324 (which comprises the results obtained using the query embedding 216), the scoring and ranking engine 314 may determine a similarity score for each of the documents within the first set 324. The similarity score, in an example, may be a cosine similarity score. The scores for each of the documents in the first set 324 may be stored in score(s) 330. In an example, the scoring of the documents in the first set 324 may be based on one or more additional factors. As may be understood, a document which is accessed more frequently as compared to other documents, may be considered more relevant as compared to other documents. In such an instance, in addition to the similarity score, the number of times any given document has been historically accessed may also be considered for the purposes of scoring the documents in the first set 324. It is pertinent to note that the number of times a document is accessed is only presented as one of the many other additional factors that may be considered. Such other factors would be considered as further examples of the present subject matter. The similarity score for the documents in the first set 324 may be stored as score(s) 330. For example, if documents D1, D2, D3, or D4 are present in the first set 324, their similarity score, may be determined as 0.3, 0.4, 0.2, 0.5.

The documents within the second set 326 and the third set 328 may also be scored. The documents in the second set 326 may be scored based term-based factors. For example, the scoring and ranking engine 314 may consider the number of times a specific term (which may be a parameter in the term-based query 218), is present in a document, for determining a score. Greater the number of times a term is appearing, the greater may be the score which may be attributed to a given document. In another example, terms which appear in fewer number of documents may also be attributed a higher score. Such scoring is generally referred to as term frequency-inverse document frequency (TD-IDF) scoring and may indicate importance of a word within a document in the document collection. Other scoring techniques may also be used without limiting the scope of the present subject matter in any manner. In an example, proximity of terms may also be considered for determining the score of the document in the document collection. For example, documents with keywords or terms which are positioned closer together, may be given a higher score. As may be understood, other factors may also be considered for scoring. In an example, if documents D2, D4, D6, or D8 are present in the first set 324, their similarity score, may be determined as 0.1, 0.4, 0.1, 0.6.

The documents in the third set 328 may also be scored, using corresponding approaches for results which are obtained using the semantic query 220. For scoring documents obtained using semantic query 220, the scoring and ranking engine 314 prioritize documents that exhibit or possess direct connections to the named entities specified in the semantic query 220. In addition to direct connections, the scoring and ranking engine 314 may also factor in the path length which may be connecting one or more nodes (which bear the details of the named entity), with shorter paths indicating higher relevance. Furthermore, the scoring and ranking engine 314 may also determine the score for the documents within the third set 328 based on frequency of named entities that may be appearing in the knowledge graph 210 (on which the semantic query 220 was executed). Based on the factors as discussed above (considered either alone or in combination with each other), the scoring and ranking engine 314 may determine the score of the documents in the third set 328. In an example, if documents D2, D5, D6, D7, or D9 are present in the first set 324, their similarity score, may be determined as 0.3, 0.1, 0.4, 0.1, 0.6. The scores of the documents in the first set 324, the second set 326, and the third set 328, may be stored as score(s) 330.

Once determined, the scoring and ranking engine 314 may determine a final rank or priority score for results obtained using the queries 318, 320, 322. The ranking of each document may be based on the score(s) 330 or may be based on the combined score(s) 330 that was provided for each of the first set 324, the second set 326, and third set 328. An example describing the determination of the For sake of explanation, the different score(s) 330 determined for the documents present in the first set 324, the second set 326, and third set 328 are provided below, in Table 1:

TABLE 1

| First set 324 | Second set 326 | Third set 328 |
|---|---|---|
| D1 = 0.3 | D2 = 0.1 | D2 = 0.3 |
| D2 = 0.4 | D4 = 0.4 | D5 = 0.1 |
| D3 = 0.2 | D6 = 0.1 | D6 = 0.4 |
| D4 = 0.5 | D8 = 0.6 | D7 = 0.1 |
| | | D9 = 0.6 |

As may be gathered from the table provided, document D2 commonly appears in the first set 324, the second set 326, and the third set 328. In the same manner, document D4 is present in the first set 324 and the second set 326, where document D6 is present in the second set 326 and the third set 328. Other documents are not appearing in more than one sets. It may be noted that the above table is only an illustrative examples and is not to be considered as limiting the scope of the claims in any way.

For the documents which do not appear in more than one set, the scoring and ranking engine 314 may determine the rank to be the same as the score indicated in the table above. For documents which are appearing in more than one set, the scoring and ranking engine 314 may utilize the scores allocated to such documents and determine a combined rank or priority score for such documents. In the context of the example table depicted above, it may be gathered that the following documents have the following values which are collated in Table 2, below:

TABLE 2

| Document | First set 324 | Second set 326 | Third set 328 |
|---|---|---|---|
| D2 | 0.4 | 0.1 | 0.3 |
| D4 | 0.5 | 0.4 | — |
| D6 | — | 0.1 | 0.4 |

Based on the respective scores as recorded above, the scoring and ranking engine 314 may determine a final rank for the document, say document D1. For example, the scoring and ranking engine 314 may determine an average value based on the scores recorded above, and accordingly determine the value of the rank for D1. In an example, the rank thus determined for document D1 may be stored as rank(s) 332. In a similar manner, the ranks for D4 and D6 may be determined and stored as rank(s) 332.

In yet another example, weights may be assigned to each score(s) 330 for determining the value of the rank(s) 332. By way of example, a weight factor w1 may be attributed for results that may have been obtained using query embedding 318, i.e., the documents in the first set 324. The value of the weight factor w1, in the present example, is indicative of semantic relevance. Higher value of the weight factor w1 implies that the semantic relevance is critical for the search which is being conducted. In a similar manner, weight factors w2 and w3 may be attributed for results that may have been obtained using the term-based query 320 and the semantic query 322, i.e., the documents in the second set 326 and the third set 328, respectively. The weight factor w2 may indicate relevance of specific or exact keywords based on the query, with the weight factor w3 being indicative of the relevance of entity (i.e., the named entities) relationships. Thus, a higher value of w2 would imply that the exact matches are preferred, whereas a higher value of w3 would imply that results bear relationship between the named entities, wherein the named entities may be such that may have been specified in the query 214. In an example, the values of the different weights may be stored as weight(s) 334.

By way of example, the rank(s) 332 for any given document may be determined based on the following equation:

$$Rank ( s ) = w 1 * [ semantic score ] + w 2 * [ inverted index score ] + w 3 * [ knowledge graph score ] \qquad ( Equation 1 )$$

In the context of the above respective scores as recited in Table 1, an example score of the different documents may be determined by the scoring and ranking engine 314. For example, for document D2, the different values of the semantic scores, inverted index score and knowledge graph score are as follows:

TABLE 3

| Document | First set 324 | Second set 326 | Third set 328 |
|---|---|---|---|
| D2 | 0.4 | 0.1 | 0.3 |

Using the above values for document D2, and using the values of the weight(s) 334, the scoring and ranking engine 314 may determine the final rank of the document D2 using the equation 1. For the present example, the values of the different weight(s) 334 is w1=0.2, w2=0.5, w3=0.3 (thereby indicating a higher relevance to results from queries executed on the inverted index). Considering these values, the rank(s) 332 determined for the different documents as listed in Table 2 are provided in the updated Table 4, provided below:

TABLE 4

| Document | First set 324 | Second set 326 | Third set 328 | Rank (s) 332 |
|---|---|---|---|---|
| D2 | 0.4 | 0.1 | 0.3 | 0.22 |
| D4 | 0.5 | 0.4 | — | 0.3 |
| D6 | — | 0.1 | 0.4 | 0.17 |

It may be noted that the values of the rank(s) 332 for other documents would be dependent on the scores as exemplified previously. The same have not been depicted here for sake of brevity. It may also be noted that the above approach for determining the rank(s) 332 is only indicative and is not to be considered as a limitation. These are only examples and other approaches (say for determining the rank(s) 332) may also be adopted without limiting the scope of the claimed subject matter.

Proceeding further, once the rank(s) 332 is determined, the query processing engine 312 may further elect one or more documents based on a predefined criteria or any other predefined rule and the rank(s) 332. For the purposes of explanation, one such example condition that may be used by the scoring and ranking engine 314 is that documents having rank(s) 332 greater than 0.2 are to be considered. With this as the example condition, the scoring and ranking engine 314 may elect the documents D2 and D4 (considering that the corresponding rank(s) 332 is greater than 0.2). Other conditions in conjunction with, or independent of each other, may be adopted without deviating from the scope of the present subject matter. For example, the scoring and ranking engine 314 may consider a percentile number of documents (say a percentage of the higher-scoring documents). In another example, the scoring and ranking engine 314 may elect one or more documents based on a diversification criteria. For example, the scoring and ranking engine 314 may determine two or more documents which may be highly similar. Of such documents, the scoring and ranking engine 314 may elect the document having a higher value of the rank(s) 332. In another example, the scoring and ranking engine 314 may consider the nature and extent of subtopics for a main topic. Other criteria that may be adopted include, but are not limited to, recent updates effected on documents, extent of user engagement, proximity of one or more keywords, or such.

Once the scoring and ranking engine 314 has applied the above criteria, the documents (in the present instance, say documents D2 and D4) may be provided as a result to the user 202, in response to the query 214. In an example, the query processing engine 312 may use the large-language model 340 for providing a response to the query 214. In an example, the response may be stored as result(s) 336. The large-language model 340 may be trained or ‘fine-tuned’ based on domain specific knowledge (e.g., either based on knowledge pertaining to the legal or medical field). Accordingly, the query processing engine 312 may provide an articulated reply considering the results (e.g., D2 and D4) while responding to the query 214. As may be noted, the above approaches provide an output which is based on combining ontology, semantic search, and inverted indexes, thereby optimizing retrieval efficiency and as well as furthering contextual accuracy, while formulating replies to queries provided by users, such as the user 202. The present approaches while relying on ontological relationships which are present in knowledge graphs are able to provide a reply by accordingly adapting the outcome depending on the different contexts and user intents, and also based on the query received from the user.

As described previously, the query processing engine 312 may execute the query embedding 318, the term-based query 320, and the semantic query 322, on the embedding repository 206, the inverted index 208 and the knowledge graph 210. In an example, each of the embedding repository 206, the inverted index 208 and the knowledge graph 210 may prepared using documents that may be pertinent to a knowledge domain. Knowledge domain may be understood as a specific area of expertise or subject matter that the machine-learning based system may be implemented with or configured/trained on. Example of knowledge domain may include, information having degree of generality or specificity, pertaining to specific fields such legal, technical, or medical fields. As described previously, the knowledge domain may also refer to the corpus of information pertaining to an organization resource, such as an industrial facility. In this context, the documents may pertain to operational aspects of the industrial facility. In such a manner, the present approaches may be adopted to address queries for any field, where information may be made available.

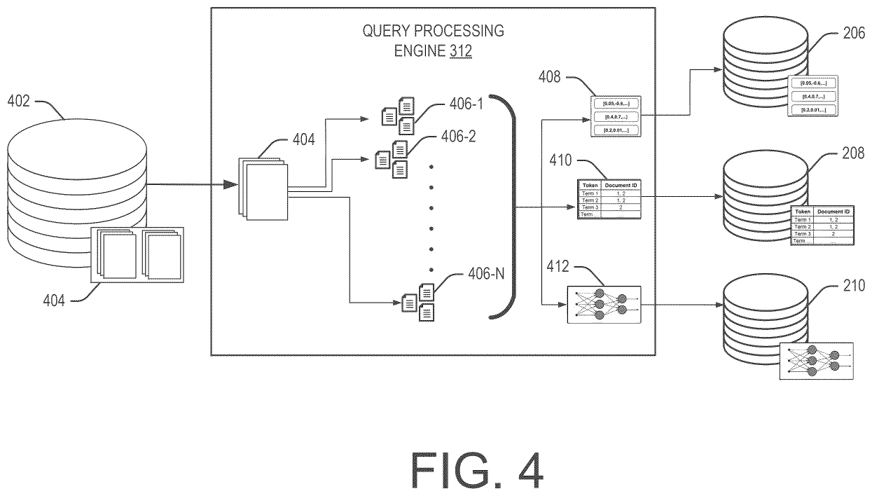

FIG. 4 provides an example environment 400, in which documents from the document collection may be retrieved and processed to prepare the embedding repository 206, the inverted index 208, and the knowledge graph 210. In an example, the embedding repository 206, the inverted index 208 and the knowledge graph 210 may be prepared by the query processing engine 312, implemented within the system 204. The environment 400 may include the system 204 which is in communication with the document collection 402. The document collection 402 may include one or more documents. The documents may pertain to a specific knowledge domain. Although depicted as persisting in a single repository, the document collection 402 may be composed of multiple repositories storing different sets of documents to form the document collection 402. Such different repositories may be in communication with each other over a network. The document collection 402 in turn may be operationally managed by computing resources (not shown in FIG. 4 for sake of brevity).

In an example, the query processing engine 312 within the system 204 may initially receive document(s) 404 from the document collection 402. In an example, the document(s) 404 may pertain to knowledge domain. Proceeding further, the query processing engine 312 processes the document(s) 404 to obtain one or more segmented document portions. In relation to a document, the segmented document portion may be a single page or a collection of a definite number of pages, in a PDF file. The segmented document portion may be a page (or a collection of pages) in another file format as well, without deviating from the scope of the present subject matter.

Once the segmented document portion is obtained, the query processing engine 312 may parse the segmented document portion to identify text-based content, such as one or more keywords. The keywords in turn are processed to form chunk(s) 406-1, 2, . . . , N (collectively referred to as chunk(s) 406). In an example, the chunk(s) 406 may be considered as segment of text that is split or derived from the segmented document portions. Basis this, multiple chunk(s) 406 (pertaining to different keywords) may be determined from the segmented document portions. The chunk(s) 406, in an example, may provide certain degree of semantic coherence or other factors that may be relevant to the document(s) 404 being processed.

The query processing engine 312 may form chunk(s) 406 based on different parameters. For example, the query processing engine 312 may process the segmented document portions to yield chunk(s) 406 which are segments of texts of a predefined length. In another example, the chunk(s) 406 may be formed basis the structure of the document (e.g., if derived from paragraphs). Multiple other approaches, either alone or combination with each other, may be adopted for obtaining such chunk(s) 406. Such approaches would still be examples of the present subject matter.

The chunk(s) 406 once obtained may be further processed by the query processing engine 312 to prepare embeddings, such as embedding(s) 408, which may then be persisted within the embedding repository 206. Prior to creating the embedding(s) 408, the query processing engine 312 may preprocess the chunk(s) 406, wherein which the text may be normalized or formatted to remove any extraneous content. Thereafter, the chunk(s) 406 may be used for generating embedding(s) 408. Embeddings may be considered as an encoded representation of the semantic meaning of the words into an array or vector of numbers. As may be understood, in such a representation words with similar meanings are represented by similar vectors in a high-dimensional vector space. In an example, the embedding(s) 408 may be generated using a transformer model (or any other suitable embedding model). Each of the vector embeddings may thereafter be stored in the embedding repository 206.

As mentioned previously, the inverted index 208 may also be prepared based on the document collection pertaining to a specific knowledge domain. An inverted index may be considered as a data structure which is commonly used in information retrieval systems, such as search engines. Using an inverted index allows locating document(s) 404 which include specific terms, quicky and efficiently based on a mapping of terms (words) to their locations in a dataset (e.g., document(s) 404 within the document collection). In an example, the query processing engine 312 may process document(s) 404 to prepare the inverted index 208. To this end, the query processing engine 312 may tokenize document(s) 404 within the document collection. As may be understood, tokenization, in an example, may involve segmenting text content present within the document into individual tokens, or words. In addition (or as the situation may require), the query processing engine 312 may convert all text to lowercase for consistency, removing punctuation and/or special characters, or such other processing tasks to normalize the tokens. Additional preprocessing steps may be performed (e.g., stemming or lemmatization, or such) without deviating from the scope of the present subject matter. Thereafter, the query processing engine 312 may map each unique term to document identifiers of the document(s) 404 present within the document collection. The mappings, such as mapping(s) 410, may then be organized into a structured data format, where terms may be used as keys and their corresponding values include lists of document identifiers or metadata. The resulting index may be stored as inverted index 208 (as shown in FIG. 2).

With respect to the knowledge graph 210, the query processing engine 312 may commence to process the document(s) 404 within the document collection. In an example, the query processing engine 312 may process the document(s) 404 through a number of preprocessing steps which include, but are not limited to, text normalization, tokenization, and linguistic analysis, or such. For example, the query processing engine 312 may process the document(s) 404 to generate one or more tokens. Based on the processing, the query processing engine 312 may derive the entity and their relationship. The query processing engine 312 may then, using named entity recognition (NER), identify and classify key entities within the text into predefined categories. The types of categories may depend on the information contained within the document(s) 404 of the document collection. For example, the query processing engine 312 may identify various named entities such as persons, organizations, locations, dates, and/or domain-specific concepts, based on the processing of the document(s) 404 to generate the knowledge graph. The knowledge graph thus generated may be saved in a repository, referred to as the knowledge graph 210. In another example, the query processing engine 312 may process the document(s) 404 to convert texts or chunk(s) 406 into an ontology 412. The ontology 412 may thereafter be used by the query processing engine 312 for preparing the knowledge graph 210.

The above approaches describe some example methods that may be adopted for creating the embedding repository 206, the inverted index 208, and the knowledge graph 210. It is pertinent to note that the above approaches are just few of the many other examples that may be adopted for creating the embedding repository 206, the inverted index 208, and the knowledge graph 210. It is also submitted that even though embedding repository 206, the inverted index 208 and the knowledge graph 210 are shown as separate, they may be implemented in a single repository, or distributed across multiple other repositories, without deviating from the scope of the present subject matter.

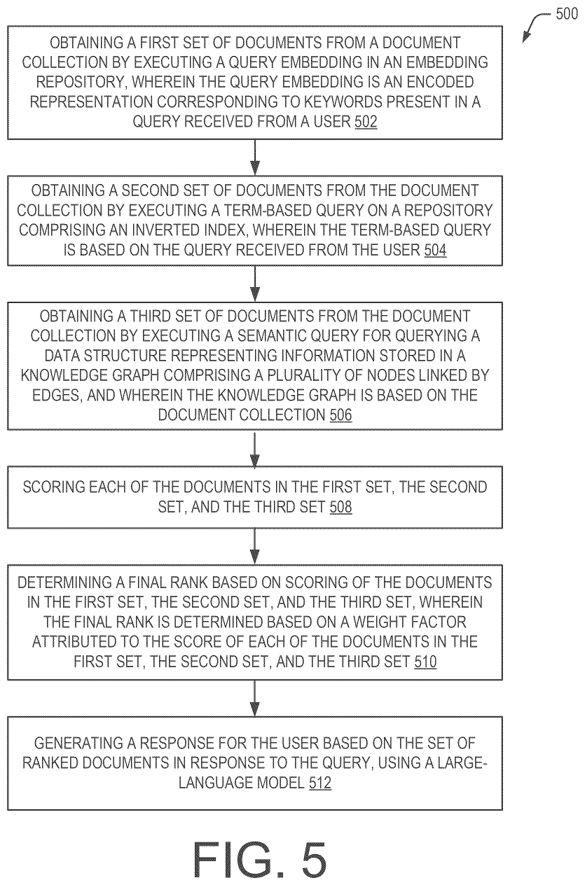

FIG. 5 illustrates a method 500 for generating a response for a user based on the set of ranked documents, as per an example. The order in which the above-mentioned method is described is not in-tended to be construed as a limitation, and some of the described method blocks may be combined in a different order to implement the method, or an alternative method.

Furthermore, the above-mentioned method may be implemented in suitable hardware, computer-readable instructions, or combination thereof. The steps of such method may be performed by either a system under the instruction of machine executable instructions stored on a non-transitory computer readable medium or by dedicated hardware circuits, microcontrollers, or logic circuits. For example, the method may be performed by the query processing system 102 or 204. In an implementation, the method may be performed under an “as a service” delivery model, where the system 102 or 204, operated by a provider, receives programmable code or executable instances which allow such a recipient to generating a response for a user based on the set of ranked documents. Herein, some examples are also intended to cover non-transitory computer readable medium, for example, digital data storage media, which are computer readable and encode computer-executable instructions, where said instructions perform some or all the steps of the above-mentioned methods.

At block 502, a first set of documents may be obtained from a document collection pursuant to a query embedding being executed on an embedding repository. As may be understood, the query embedding is an encoded representation corresponding to keywords present in a query received from a user. For example, the query embedding 318 (in the form of a vector embedding) may be used by the query processing engine 312 for searching and identifying documents, from amongst the document collection 402 based on the comparison between the vector/embedding corresponding to the query 214 and the vector/embedding corresponding to one or more documents. These documents may be saved as the first set 324.

At block 504, a second set of documents from the document collection may be obtained by executing a term-based query on a repository comprising an inverted index. As may be understood, the term-based is based on the query received from the user. For example, the query processing engine 312 may also process the query 214 to generate the term-based query 320. To this end, the query processing engine 312 may process the query 214 to obtain segmented keywords. Once the keywords are obtained, a query may be structured based on one or more of the keywords as the parameter. The term-based query 320 once is executed on an inverted index, such as the inverted index 208. The results obtained as a result of the execution of the term-based query 320, are stored as the second set 326.

At block 506, a third set of documents from the document collection may be obtained by executing a semantic query for querying a data structure in the form of a knowledge graph. For example, the query processing engine 312 may also process the query 214 to generate the semantic query 322. The semantic query 322 may be in the form of a graph query language. Thereafter, the query processing engine 312 may cause the execution of said the semantic query 220 on the knowledge graph 210. The results obtained as a result of the execution of the semantic query 322 may be stored as the third set 328.

At block 508, each of the documents in the first set, the second set, and the third set may be scored and a final rank may be obtained. The final rank is determined based on a weight factor attributed to the score of each of the documents in the first set, the second set, and the third set. For example, with respect to the first set 324 (which comprises the results obtained using the query embedding 216), the scoring and ranking engine 314 may determine a similarity score for each of the documents within the first set 324. The similarity score, in an example, may be a cosine similarity score. In a similar manner, documents within the second set 326 and the third set 328 may also be scored. The documents in the second set 326 may be scored based term-based factors. For example, the scoring and ranking engine 314 may consider the number of times a specific term (which may be a parameter in the term-based query 218), is present in a document, for determining a score. The documents in the third set 328 may also be scored, using corresponding approaches for results which are obtained using the semantic query 220. For scoring documents obtained using semantic query 220, the scoring and ranking engine 314 prioritize documents that exhibit or possess direct connections to the named entities specified in the semantic query 220. Once determined, the scoring and ranking engine 314 may determine a final rank or priority score, say based on the Equation 1, as provided above. In an example, the final rank may be stored as rank(s) 332.

At block 510, a response for the user based on the set of ranked documents may be generated in response to the query, using a large-language model. For example, once the rank(s) 332 is determined, the query processing engine 312 may further elect one or more documents based on a predefined criteria or any other predefined rule and the rank(s) 332. The documents (as per the example illustrated in conjunction with FIG. 3, i.e., say documents D2 and D4) may be provided as results to the user 202, in response to the query 214. In an example, the query processing engine 312 may use the large-language model 340 for providing a response to the query 214. In an example, the response to the query 214 may be stored as result(s) 336.

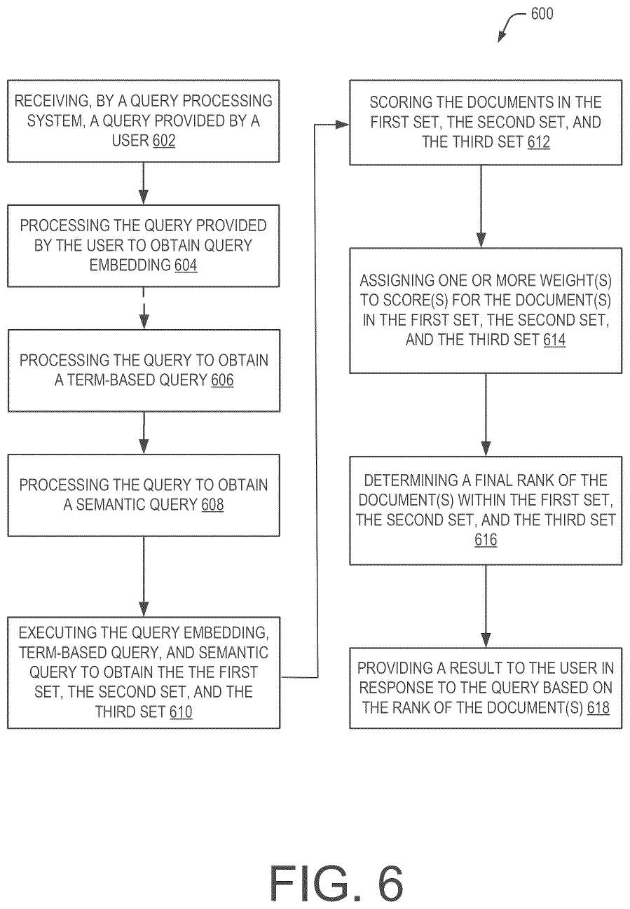

FIG. 6 illustrates another method 600 for generating a response for a user based on the set of ranked documents, as per an example. The order in which the above-mentioned methods are described is not intended to be construed as a limitation, and some of the described method blocks may be combined, or may be implemented in a different order to implement the method, or an alternative method of the present example. Similar to the method 500, the present method may be implemented by the system 204, as per one example. The above-mentioned methods are explained from the perspective of a responding to queries that may be posed, in relation to a knowledge domain, and wherein which the response may be provided based on documents within a document collection, such as the document collection 402.

At block 602, query provided by a user may be received. For example, the user 202 may interact or engage with the query processing system 204 and pose query 214. It may be noted that the query 214 may correspond to a knowledge domain or other concepts against which the query 214 may have been posed. In an example, the received from the user 202 may be presented in natural language (i.e., without adhering to any querying specific syntax). The manner in which the query 214 may be posed may vary without limiting the scope of the present subject matter. For example, the query 214 (which may be in a natural language form) may be provided to the system 204 as a text-based input. In another example, the query 214 may be provided in the form of an audio input provided by the user 202, where the audio-based input is converted to a text-based input which may then be processed as the query 214. Any other mechanism may also be adopted without deviating from the scope of the present subject matter.

At block 604, the query provided by the user may be processed to obtain a query embedding. For example, the query processing engine 312 may process the query 214 to generate a query embedding, which in turn is stored as query embedding 318 within data 310. Embeddings may be understood as an encoded representation of semantic meanings of the words into an array or vector of numbers. In such a representation, words with similar meanings are represented by similar vectors in a high-dimensional vector space. In an example, the query processing engine 312 may, using a transformer model (or any other approach) convert the text into a series of numbers which may be arranged in an array. Once the generated, the array (i.e., a vector, if represented in a higher-dimensional vector space) may be stored as the query embedding 318. For generating the query embedding 318, the query processing engine 312 may segment the input text forming part of the query 214 into one or more discrete units, or words. The segmented units may be collated into a logical sequence or set, the elements of which include each of the words that may be appearing in the query 214. For example, the query processing engine 312 may segment an example text string “What are the environmental laws in Country A?” may be transformed into the sequence [“What”, “are”, “the”, “environmental”, “laws”, “in”, “Country A”, “?”]. In an example, the terms thus obtained may be stored as other data 338. In addition to such processing as just exemplified, the query processing engine 312 may further perform additional processing, such as formatting, removing punctuation, or such other actions to normalize the terms that have been obtained.

At block 606, in addition to the query embedding, a term-based query may be generated based on the query provided by the user. For example, the query processing engine 312 may also process the query 214 to generate the term-based query 320. For generating the term-based query 320, the query processing engine 312 may process the query 214 to obtain segmented keywords, in a manner which is similar to the generation of the query embedding 318 (as discussed above). Once the keywords are obtained, a query may be structured based on one or more of the keywords as the parameter. The query thus generated may be stored as term-based query 320.

At block 608, a semantic query may be additionally generated based on the query provided by the user. For example, for generating the semantic query 322, the query processing engine 312 may parse the query 214 received from the user 202 to determine one or more named entities. In an example, a named entity may be considered as representative of any real-world object or entity instances. Based on the named entities, the query processing engine 312 may generate the semantic query 322. In an example, the semantic query 322 may be in the form of a graph query language. Examples of such a structured query language includes, but is not limited to, SPARQL or Cypher. Other forms of query language may also be used without deviating from the scope of the present subject matter.

Although exemplified as being generated in an order, the query embedding 318, the term-based query 320, and the semantic query 322 may be generated in any order by the query processing engine 312, without deviating from the scope of the present subject matter. This may also include generating the query embedding 318, the term-based query 320, and the semantic query 322, simultaneously by either the same functional entity (such as the query processing engine 312) or through multiple functional entities, without limiting the scope of the claims, as presented herein. The above are only examples, and the present approaches are not limited to the instances as explained above.

At block 610, the query embedding, the term-based query, and the semantic query, are executed. For example, once the query embedding 318, the term-based query 320, and the semantic query 322 (collectively referred to as queries 318, 320, 322), are generated, the query processing engine 312 may cause the execution of said the queries 318, 320, 322 on the embedding repository 206, the inverted index 208 and the knowledge graph 210, respectively. As may be understood, each of the queries 318, 320, 322 may specify one or more parameters or arguments, which form the basis for recovering documents from a document collection, such as the document collection 402. Based on the parameters that are specified in the respective queries 318, 320, 322, the documents from a document collection may be identified. In an example, the documents, such as the document(s) 404, that may be retrieved based on the execution of the queries 318, 320, 322, may be stored and maintained within the system 204 as first set 324, second set 326, and the third set 328. For example, the execution of the query embedding 216 on the embedding repository 206 yields documents which are stored as the first set 324. In a similar manner, documents retrieved as a result of the execution of the term-based query 218 and the semantic query 220 may be stored as the second set 326 and the third set 328, respectively. The manner which the identification of the documents is performed may differ depending on the type of query. For example, for the query embedding 216, the similarities between the query embedding 318 and the document(s) 404 may be determined by determining cosine similarity (in an example) between the vector/embedding corresponding to the query 214 and the vector/embedding corresponding to the document(s) 404 within the document collection 402. For the term-based query 218, the keyword or terms provided as parameters specified in the term-based query 218 are used as the basis for identifying and searching for documents in the document collection. For the semantic query 220, the names entities in the semantic query 220 is used as the basis for searching the documents in the document collection.

At block 612, documents within the first set, the second set, and the third set may be scored. For example, the scoring and ranking engine 314 may process the document(s) 404 within the first set 324, second set 326, and the third set 328 to identify one or more ranked documents. To this end, the documents within the first set 324, the second set 326, and the third set 328 may be initially scored. For example, with respect to the first set 324 (which comprises the results obtained using the query embedding 216), the scoring and ranking engine 314 may determine a similarity score for each of the documents within the first set 324 (e.g., a cosine similarity score), which in turn may be stored in score(s) 330. In an example, the scoring of the documents in the first set 324 may be based on one or more additional factors. In addition, the documents within the second set 326 and the third set 328 are also scored.

The documents in the second set 326 may be scored based on term-based factors. For example, the scoring and ranking engine 314 may consider term frequency-inverse document frequency (TD-IDF) scoring. Other scoring techniques may also be used without limiting the scope of the present subject matter in any manner. The documents in the third set 328 may also be scored, using corresponding approaches for results which are obtained using the semantic query 220. For scoring documents obtained using semantic query 220, the scoring and ranking engine 314 prioritize documents that exhibit or possess direct connections to the named entities specified in the semantic query 220. In addition to direct connections, the scoring and ranking engine 314 may also factor in the path length which may be connecting one or more nodes (which bear the details of the named entity), with shorter paths indicating higher relevance. Furthermore, the scoring and ranking engine 314 may also determine the score for the documents within the third set 328 based on frequency of named entities that may be appearing in the knowledge graph 210 (on which the semantic query 220 was executed). The scores of the documents in the second set 326, and the third set 328, may be stored as score(s) 330.

At block 614, one or more weights may be assigned to each score(s) determined for the document(s). For example, the scoring and ranking engine 314 may assign weights to each score(s) 330. By way of example, a weight factor w1 may be attributed for results that may have been obtained using query embedding 318, i.e., the documents in the first set 324. The value of the weight factor w1, in the present example, is indicative of semantic relevance. Higher value of the weight factor w1 implies that the semantic relevance is critical for the search which is being conducted. In a similar manner, weight factors w2 and w3 may be attributed for results that may have been obtained using the term-based query 320 and the semantic query 322, i.e., the documents in the second set 326 and the third set 328, respectively. The weight factor w2 may indicate relevance of specific or exact keywords based on the query, with the weight factor w3 being indicative of the relevance of entity (i.e., the named entities) relationships. Thus, a higher value of w2 would imply that the exact matches are preferred, whereas a higher value of w3 would imply that results bear relationship between the named entities, wherein the named entities may be such that may have been specified in the query 214. In an example, the values of the different weights may be stored as weight(s) 334.

At block 616, a final rank of documents in the first set, the second set, and the third set may be determined. In an example, the final rank may be determined based on one or more weights assigned to each of the score(s). For example, the scoring and ranking engine 314 may determine a final rank or priority score for results in the first set 324, the second set 326, and the third set 328. The ranking of each document may be based on the score(s) 330. The manner in which the ranking may be determined is as per the example(s) described previously with reference to the Table(s) 1-4, as per an example. Proceeding further, based on the respective scores as recorded above, the scoring and ranking engine 314 may determine a final rank, i.e., rank(s) 332, for the document, say document D1. In an example, the rank(s) 332 may be determined based on the weights using Equation 1 (as provided earlier), as per an example:

$$Rank ( s ) = w 1 * [ semantic score ] + w 2 * [ inverted index score ] + w 3 * [ knowledge graph score ] \qquad ( Equation 1 )$$

At block 618, one or more documents may be provided as a result to the user, in response to the query. For example, once the rank(s) 332 is determined, the query processing engine 312 may further elect one or more documents based on a predefined criteria or any other predefined rule and the rank(s) 332. The rules may specify a threshold value of the rank(s) 332 or other criteria based on which one or more documents may be selected. In an example, the query processing engine 312 may use the large-language model 340 for providing a response to the query 214. The response may be stored as result(s) 336. The result(s) 336 may be provided to the user 202 or may be persisted for later retrieval. The large-language model 340 may be trained or ‘fine-tuned’ based on domain specific knowledge (e.g., either based on knowledge pertaining to the legal or medical field). Accordingly, the query processing engine 312 may provide an articulated reply considering the results (e.g., D2 and D4 as per the example described previously).

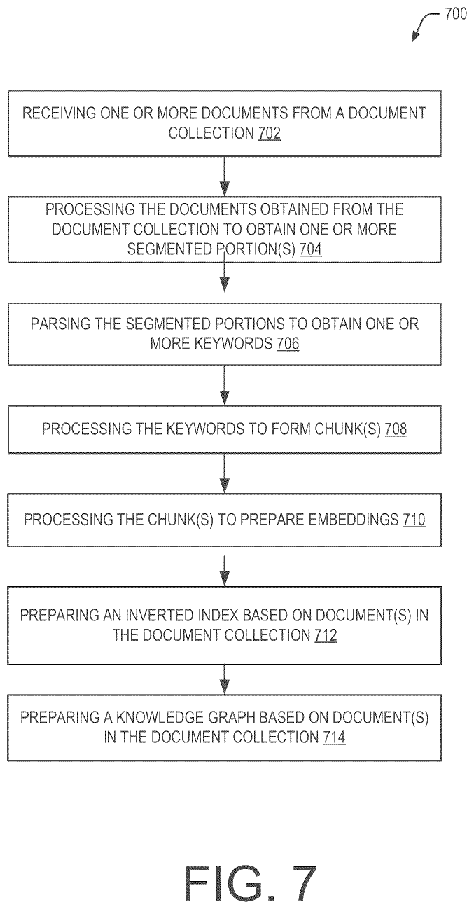

FIG. 7 provides an example method to prepare an embedding repository, an inverted index, and a knowledge graph. In an example, the embedding repository, the inverted index, and the knowledge graph may be prepared or realized within the system 204. These example methods are described in the context of approaches discussed in conjunction with the environment 400 comprising the system 204 which communicates with the document collection 402.

At block 702, one or more documents are received from a document collection. For example, the query processing engine 312 within the system 204 may initially retrieve one or more document(s) 404 from the document collection 402. The document(s) 404 may pertain to a knowledge domain. Knowledge domain may be understood as a specific area of expertise or subject matter that the machine-learning based system may be implemented with or configured/trained on. Example of knowledge domain may include, information having degree of generality or specificity, pertaining to specific fields such legal, technical, or medical fields. In another example, the knowledge domain may pertain to various functional, operational or any other type of information pertaining to organizational resources, such as industrial facilities, or such. It may be noted that such examples of knowledge domains are only indicative.

At block 704, the documents may be processed to obtain one or more segmented document portions. For example, the query processing engine 312 processes the document(s) 404 to obtain one or more segmented document portions. In an example, the segmented document portion may be a single page or a collection of a definite number of pages, in a PDF file, or another file format, or a combination thereof.

At block 706, the segmented document portions may be parsed. For example, once the segmented document portion is obtained, the query processing engine 312 may parse the segmented document portion to identify text-based content, such as one or more keywords. The parsing of the segmented document portions may be performed serially or in batch mode, without deviating from the scope of the present subject matter. In an example, the segmented document portions may be collated into a logical sequence or set, the elements of which include each of the words that may be appearing in the query, say query 214.

At block 708, the keywords thus obtained are processed to form chunk(s). The keywords in turn are processed to form chunk(s), such as the chunk(s) 406-1, 2, . . . , N (collectively referred to as chunk(s) 406). In an example, the chunk(s) 406 may be considered as segment of text that is split or derived from the segmented document portions. Basis this, multiple chunk(s) 406 (pertaining to different keywords) may be determined from the segmented document portions. The chunk(s) 406, in an example, may provide certain degree of semantic coherence or other factors that may be relevant to the document(s) 404 being processed. In an example, the query processing engine 312 may form chunk(s) 406 based on different parameters, such as predefined length of segments, or other criteria. In another example, the chunk(s) 406 may be formed basis the structure of the document (e.g., if derived from paragraphs). Multiple other approaches, either alone or combination with each other, may be adopted for obtaining such chunk(s) 406.

At block 710, the chunk(s) may be processed to prepare embeddings. For example, the query processing engine 312 may process the chunk(s) 406 to prepare embeddings (corresponding to the document(s) 404 within the document collection 402). The embedding thus obtained may then be persisted within the embedding repository 206. Embeddings may be considered as an encoded representation of the semantic meaning of the words into an array or vector of numbers. As may be understood, in such a representation words with similar meanings are represented by similar vectors in a high-dimensional vector space. In an example, the embedding may be generated using a transformer model (or any other suitable embedding model). Each of the vector embeddings may thereafter be stored in the embedding repository 206. In an example, prior to creating the embeddings, the query processing engine 312 may preprocess the chunk(s) 406, wherein which the text may be normalized or formatted to remove any extraneous content. Other actions may also be performed to further process the chunk(s) 406.

At block 712, an inverted index may be prepared based on the documents within the document collection. An inverted index may be considered as a data structure which is commonly used in information retrieval systems, such as search engines. Using an inverted index allows locating document(s), which include specific terms, quicky and efficiently based on a mapping of terms (words) to their locations in a dataset. In an example, the query processing engine 312 may document(s) 404 to prepare the inverted index 208. To this end, the query processing engine 312 may initially tokenize document(s) 404 within the document collection 402 and/or further process the document(s) 404 within the document collection 402 (e.g., converting all text to lowercase, removing punctuation and/or special characters, or such other processing tasks to normalize the tokens). Thereafter, the query processing engine 312 may map each unique term to document identifiers of the document(s) 404 present within the document collection. The mappings may then be organized into a structured data format, where terms may be used as keys and their corresponding values include lists of document identifiers or metadata. The resulting index may be stored as inverted index 208 (as shown in FIG. 2).

At block 714, a knowledge graph may be prepared based on the document(s) within the document collection. For example, the query processing engine 312 may perform a number of preprocessing steps onto the document(s) 404, steps which include, but are not limited to, text normalization, tokenization, and linguistic analysis, or such. Based on the processing, the query processing engine 312 may derive entity and their relationship. The query processing engine 312 may then, using named entity recognition (NER), identify and classify key entities within the text into predefined categories. The types of categories may depend on the information contained within the document(s) 404 of the document collection. For example, the query processing engine 312 may identify various named entities such as persons, organizations, locations, dates, and/or domain-specific concepts, based on the processing of the document(s) 404 to generate the knowledge graph. The knowledge graph thus generated may be saved as the knowledge graph 210. In another example, the query processing engine 312 may process the document(s) 404 to convert texts or chunk(s) 406 into an ontology 408. The ontology 408 may thereafter be used by the query processing engine 312 for preparing the knowledge graph 210.

Although the creation of the embedding repository 206, the inverted index 208 and the knowledge graph 210 has been described in a specific sequence, above, it may be noted that the same is not to be construed as a limitation. Either of the embedding repository 206, the inverted index 208 and the knowledge graph 210 may be prepared in any order, or simultaneously without impacting the scope of the protection being sought in any manner. These may also be created as instances separated by considerable intervals of times or may even be prepared by different entities. Such instances are only examples of the present subject matter.

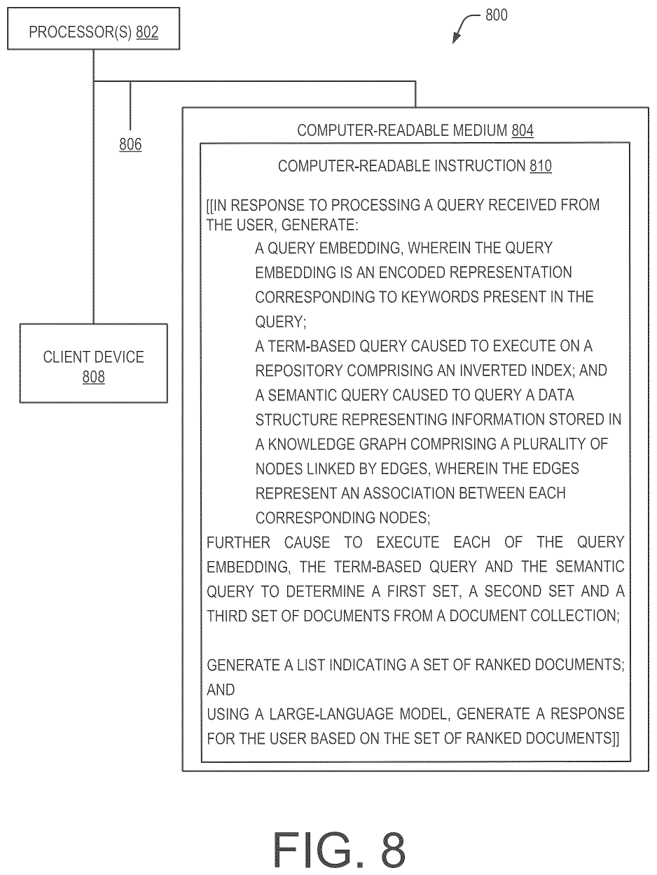

FIG. 8 illustrates a non-transitory computer-readable medium 800 for generating a response for a user based on the set of ranked documents, in accordance with an example of the present subject matter. In an example, the non-transitory computer-readable medium 800 includes processor 802 communicatively coupled to a non-transitory computer readable medium 804 through communication link 806. In an example, the processor 802 may have one or more processing resources for fetching and executing computer-readable instructions from the non-transitory computer readable medium 804. The processor 802 and the non-transitory computer readable medium 804 may be implemented, for example, in the query processing system 102.

The non-transitory computer readable medium 804 may be, for example, an internal memory device or an external memory. In an example implementation, the communication link 806 may be a network communication link, or other communication links, such as a PCI (Peripheral component interconnect) Express, USB-C (Universal Serial Bus Type-C) interfaces, I2C (Inter-Integrated Circuit) interfaces, etc. In an example implementation, the non-transitory computer readable medium 804 includes a set of computer readable instructions 810 which may be accessed by the processor 802 through the communication link 806 and subsequently executed for reconfiguring the data pipeline. The processor(s) 802 and the non-transitory computer readable medium 904 may also be communicatively coupled to a computing device 808 over the network.

Referring to FIG. 8, in an example, the non-transitory computer readable medium 804 includes computer readable instructions 810 that cause the processor 802 to generate a response for a user based on the set of ranked documents. In an example, the instructions 810 may cause the processor 802 to generate a query embedding (such as the query embedding 318), a term-based query (such as the term-based query 320), and a semantic query (such as the semantic query 322). Each of the query embedding 318, the term-based query 320, and the semantic query 322 are generated based on a query, such as the query 214 provided by a user, for example, user 202.

In an example, the query embedding 216 is an encoded representation corresponding to one or more keywords present in the query 214. The instruction 810 are such so as to cause the term-based query 320 to be executed on a repository comprising an inverted index (such as the inverted index 208). The instructions 810 are to cause execution of the semantic query 322 on a data structure representing information stored in a knowledge graph (such as the knowledge graph 210) comprising a plurality of nodes linked by edges. The edges represent an association between each corresponding node. Once obtained, the instructions 810 are to cause the query embedding 318, the term-based query 320, and the semantic query 322 to be executed to determine a first set 322, second set 326, and a third set 328 of documents. In an example, these documents are obtained from the document collection 402.

Thereafter, the instructions 810 may be executed to generate a list indicating a set of ranked documents, based on the documents which may be present in the first set 324, second set 326, and the third set 328. In an example, the rank of the documents may be stored as rank(s) 332. Once the documents are ranked, the instructions may be executed to use a large-language model (e.g., the large-language model 340) and generate a response, such as the result(s) 336, to the query 214 based on the set of documents (e.g., the document collection 402).

Although examples of the present subject matter have been described in language specific to methods and/or structural features, it is to be understood that the present subject matter is not limited to the specific methods or features described. Rather, the methods and specific features are disclosed and explained as examples of the present subject matter.

1. A system comprising:
a processor; and
a machine-readable storage medium comprising instructions executable by the processor to:
receive a query from a user;
process the query received from the user, wherein to process the query, the processor is to generate:
a query embedding, wherein the query embedding is an encoded representation corresponding to keywords present in the query;
a term-based query, wherein the term-based query is to execute on a repository comprising an inverted index; and
a semantic query, wherein the semantic query is to query a data structure representing information stored in a knowledge graph comprising a plurality of nodes linked by edges, wherein the edges represent an association between each corresponding node;
execute each of the query embedding, the term-based query and the semantic query to determine a first set, a second set and a third set of documents from a document collection;
score the set of documents to identify set of ranked documents; and
using a large-language model, generate a response for the user based on the set of ranked documents.

2. The system as claimed in claim 1, wherein to score the set of documents, the instructions are to:
determine a score for each of the documents in the first set, the second set, and the third set;
determine a final rank based on score of each of the documents in the first set, the second set, and the third set, wherein the final rank is determined based on a weight factor attributed to the score of each of the documents in the first set, the second set, and the third set; and
based on a predefined condition and the final rank determined for each document, identify the set of ranked documents.

3. The system as claimed in claim 2, wherein the weight factor attributed to the score is determined based on type of the query received from the user.

4. The system as claimed in claim 1, wherein the instructions when executed are to further cause executing the query embedding on an embedding repository, wherein the embedding repository comprises embeddings depicting semantic context and relationships between terms present in one or more documents in the document collection.

5. The system as claimed in claim 4, wherein the query embedding in the embedding repository, the inverted index, and knowledge graph, are populated based on the document collection.

6. The system as claimed in claim 5, wherein to populate the embedding repository, the inverted index, and knowledge graph, the instructions when executed are to:
process each of the documents within the document collection to obtain segmented document portions;
convert content of each of the segmented document portions into text-based content;
process the text-based content to identify a set of keywords from the text-based content;
utilize the set of keywords to form a chunk; and
generate, based on the chunk, one of the embeddings in the embedding repository, the inverted index, and the knowledge graph.

7. The system as claimed in claim 1, wherein to generate the knowledge graph, the instruction are to:
process the chunks to generate a plurality of tokens;
identify terms of interest, concepts, and relationships between various terms of interest; and
generate the knowledge graph in a machine readable format.

8. The system as claimed in claim 1, wherein the inverted index comprises a mapping between a select term present within one or more constituent documents within the collection of document, and the corresponding one or more constituent documents in which the select term is present.

9. A method comprising:
obtaining a first set of documents from a document collection by executing a query embedding in an embedding repository, wherein the query embedding is an encoded representation corresponding to keywords present in a query received from a user;
obtaining a second set of documents from the document collection by executing a term-based query on a repository comprising an inverted index, wherein the term-based query is based on the query received from the user;
obtaining a third set of documents from the document collection by executing a semantic query for querying a data structure representing information stored in a knowledge graph comprising a plurality of nodes linked by edges, and wherein the knowledge graph is based on the document collection;
scoring each of the documents in the first set, the second set, and the third set;
determining a final rank based on scoring of the documents in the first set, the second set, and the third set, wherein the final rank is determined based on a weight factor attributed to the score of each of the documents in the first set, the second set, and the third set; and
generating a response for the user based on the set of ranked documents in response to the query, using a large-language model.

10. The method as claimed in claim 9, wherein obtaining the first set of documents comprises:
comparing the query embedding with an embedding within an embedding repository, wherein the embeddings encode semantic context and relationships between terms present in the document collection;
determining a semantic similarity score for each of the documents in the document collection, based on the determining; and
compiling a set of documents from the document collection as the first set based on the semantic similarity score and a predefined semantic condition.

11. The method as claimed in claim 9, wherein obtaining the second set of documents comprises:
comparing a parameter specified in the term-based query with a term present in the inverted index to identify a set of documents as the second set.

12. The method as claimed in claim 9, wherein obtaining the third set of documents comprises:
comparing a query object specified within the semantic query with document object specified with corresponding nodes of the knowledge graph, wherein the document object are determined based on one or more documents within the document collection;
for nodes matching the query object, determining a priority score based on direct connection between interrelated nodes, path lengths between nodes, number of times the document object appears within the knowledge graph, or combination thereof; and
compiling another set of documents from the document collection as the second set based on the priority score, a predefined semantic condition, or combination thereof.

13. The method as claimed in claim 9, wherein the weight factor attributed to the score is determined based on type of the query received from the user, the type of the query being one of full-text search, semantic search, and knowledge graph search.

14. The method as claimed in claim 13, wherein the type of the query is identified based on executable instructions implementing a predefined criteria.

15. The method as claimed in claim 9, wherein the query embedding in the embedding repository, the inverted index, and knowledge graph, are populated based on the document collection, by:
processing each of the documents within the document collection to obtain segmented document portions;
converting content of each of the segmented document portions into text-based content;
parsing the text-based content to identify a set of keywords from amongst the text-based content;
generating chunks based on the set of keywords; and
generate, based on the chunk, one of the embeddings in the embedding repository, the inverted index, and the knowledge graph.

16. A non-transitory computer-readable medium comprising instructions, the instructions being executable by a processing resource to:
in response to processing a query received from the user, generate:
a query embedding, wherein the query embedding is an encoded representation corresponding to keywords present in the query;
a term-based query caused to execute on a repository comprising an inverted index; and
a semantic query caused to query a data structure representing information stored in a knowledge graph comprising a plurality of nodes linked by edges, wherein the edges represent an association between each corresponding nodes;
further cause to execute each of the query embedding, the term-based query and the semantic query to determine a first set, a second set and a third set of documents from a document collection;
generate a list indicating a set of ranked documents; and
using a large-language model, generate a response for the user based on the set of ranked documents.

17. The non-transitory computer-readable medium of claim 16, wherein the instructions are further executable to:
determine a score for each of the documents in the first set, the second set, and the third set;
arrange each of the documents in the first set, the second set, and the third set based on the score;
determine a final rank based on score of each of the documents in the first set, the second set, and the third set, wherein the final rank is determined based on a weight factor attributed to the score of each of the documents in the first set, the second set, and the third set; and
based on a predefined condition and the final rank determined for each document, identify the set of ranked documents.

18. The non-transitory computer-readable medium of claim 17, wherein the weight factor attributed to the score is determined based on type of the query received from the user.

19. The non-transitory computer-readable medium of claim 16, wherein the instructions are further executable to cause execution of the query embedding on an embedding repository, wherein the embedding repository comprises embeddings depicting semantic context and relationships between terms present in the document collection.

20. The non-transitory computer-readable medium of claim 16, wherein the query embedding in the embedding repository, the inverted index, and knowledge graph, are populated based on the document collection.
